(19) United States
(12) Patent Application Publication
(10) Pub. No.: US 2015/0136874 A1
(43) Pub. Date: May 21, 2015

(54) VIBRATOR INCLUDING MESH STRUCTURE AND MANUFACTURING METHOD THEREOF

(71) Applicant: Electronics and Telecommunications Research Institute, Daejeon (KR)

(72) Inventors: Han Young YU, Daejeon (KR); Yark Yeon KIM, Daejeon (KR); Yong Sun YOON, Daejeon (KR); Bong Kuk LEE, Daejeon (KR); Won Ick JANG, Daejeon (KR)

(21) Appl. No.: 14/538,693

(22) Filed: Nov. 11, 2014

(30) Foreign Application Priority Data
Nov. 18, 2013 (KR) 10-2013-0139863
Oct. 15, 2014 (KR) 10-2014-0139178

(51) Int. Cl. B05B 17/00

(52) U.S. Cl. CPC B05B 17/0646
USPC 239/102.2; 29/592.1

(57) ABSTRACT

Provided herein is a vibrator that includes a mesh structure and sprays a liquid material through the mesh structure and a manufacturing method thereof, the vibrator including the mesh structure including a vibrator structure including a hollow configured to introduce fluid from outside; a mesh structure configured to touch the hollow and include a porous mesh including a plurality of holes; and an electrode unit configured to apply a voltage for causing vibration of the vibrator structure to the vibrator, wherein the vibrator structure and mesh structure are configured as one integrated object, and the voltage is a direct voltage or alternating voltage.

### CROSS-REFERENCE TO RELATED APPLICATION

The present application claims priority to Korean patent application numbers 10-2013-0139863, filed on Nov. 18, 2013 and 10-2014-0139178, filed on Oct. 15, 2014, the entire disclosure of which is incorporated herein in its entirety by reference.

### BACKGROUND

1. Field of Invention

Various embodiments of the present invention relate to a vibrator and a manufacturing method thereof, and more particularly, to a vibrator configured to spray a liquid phase material through a mesh structure, and a manufacturing method thereof.

2. Description of Related Art

A general mesh vibrator is made by coupling a vibrator and a mesh. For example, a mesh vibrator is made by forming a hole in the vibrator so that a liquid phase material may flow through, and then by attaching a mesh to the hole using an adhesive or in a mechanical method (for example, using frictional force, tensile force, or elastic force such as fastening the mesh with a clump, or inserting the mesh into a groove structure).

FIG. 1 illustrates such a general method of manufacturing a mesh vibrator. Referring to FIG. 1, a general method of manufacturing a mesh vibrator includes a vibrator manufacturing process 11 wherein a vibrator is manufactured and a hole is formed in the vibrator manufactured, a porous manufacturing process 12 wherein a porous mesh is manufactured, a mesh coupling process 13 wherein the mesh is attached to the hole of the vibrator or coupled to the hole mechanically, and a mesh vibrator completing process 14 wherein another structure such as a power source electrode is added, the power source electrode coupled to an outside power source.

However, in such a general method, a vibrator and a mesh are manufactured separately and then coupled to each other in an additional coupling process. This makes the process too complicated, and as the mesh and vibrator are used repeatedly, they may be worn out or the binding force between the mesh and vibrator may weaken, deteriorating the durability and stability of the mesh and vibrator.

### SUMMARY

A purpose of various embodiments of the present invention is to provide a vibrator with a mesh structure that may be manufactured in a simplified process, and a manufacturing method thereof.

Another purpose of various embodiments of the present invention is to provide a mesh structure having improved durability and stability, and a manufacturing method thereof.

According to an embodiment of the present invention, there is provided a vibrator including a mesh structure, the vibrator including a vibrator structure including a hollow configured to introduce fluid from outside; a mesh structure configured to touch the hollow and include a porous mesh including a plurality of holes; and an electrode unit configured to apply a voltage for causing vibration of the vibrator structure to the vibrator, wherein the vibrator structure and mesh structure are configured as one integrated object, and the voltage is a direct voltage or alternating voltage.

The vibrator structure and mesh structure may be formed as the one integrated object through a single process of processing a lump of material into the one integrated object.

The single process may be a process of forming the one integrated object by etching or depositing the lump of material.

The mesh structure may be formed on a surface of the vibrator structure.

A portion or entirety of the mesh structure may be depressed into the vibrator structure.

The electrode unit may include a first electrode where the voltage is introduced; and a second electrode where the voltage introduced is grounded.

The first electrode may be formed on a surface of the vibrator structure, and the second electrode may be formed on another surface of the vibrator structure different from the surface.

The first electrode and second electrode may be formed on a same surface of the vibrator structure.

The fluid may proceed in a direction towards an upper surface of the mesh structure through the hollow from a lower surface of the vibrator structure.

A cross-section of the hollow may decrease as it gets closer to the mesh structure.

According to an embodiment of the present invention, there is provided a method for manufacturing a vibrator including a mesh structure, the method including forming a vibrator structure and mesh structure by processing a lump of material as one object through a single process; and forming on the vibrator structure an electrode unit configured to apply a voltage for causing vibration of the vibrator structure to the vibrator, wherein the vibrator structure and mesh structure are formed as one integrated object, the vibrator structure includes a hollow configured to introduce fluid from outside, the mesh structure touches the hollow and includes a porous mesh including a plurality of holes, and the voltage is a direct voltage or alternating voltage.

According to the various embodiments of the present invention, a vibrator including a mesh structure is manufactured in a single process. Therefore, there is no need for a process of coupling a vibrator and a mesh, and thus a vibrator including a mesh structure may be manufactured in a further simplified process compared to conventional methods.

Furthermore, according to the various embodiments of the present is invention, unlike in conventional methods where a different process is applied to a mesh and a vibrator, a mesh structure and a vibrator may be manufactured in one common process, thereby significantly simplifying the manufacturing process.

Furthermore, according to the various embodiments of the present invention, a single process of directly forming a mesh structure in a vibrator structure is applied, and thus the vibrator structure and the mesh structure may be coupled firmly. Therefore, the vibrator manufactured may be much more firm and strong compared to a mesh vibrator manufactured by mechanical method or an adhesive according to a conventional method.

Consequently, since the process is reduced and simplified, the yield rate of the vibrator including a mesh structure may be improved, the manufacturing cost may be reduced, and a physically more firm structure may be manufactured, thereby improving the durability and stability of the vibrator including the mesh structure.

### BRIEF DESCRIPTION OF THE DRAWINGS

The above and other features and advantages of the present invention will become more apparent to those of ordinary skill in the art by describing in detail embodiments with reference to the attached drawings in which:

FIG. 1 is a schematic view illustrating a method for manufacturing a general mesh vibrator;

FIG. 2 is a schematic view illustrating a method for manufacturing a vibrator including a mesh structure according to an embodiment of the present invention;

FIG. 3 is a plane cross-sectional view illustrating an exemplary structure of a vibrator including a mesh structure according to an embodiment of the present invention;

FIG. 4 is a plane cross-sectional view illustrating an exemplary structure of a vibrator including a mesh structure according to another embodiment of the present invention;

FIG. 5 is a plane cross-sectional view illustrating an exemplary structure of a vibrator including a mesh structure according to an another embodiment of the present invention; and

FIG. 6 is an exemplary flowchart of a method for manufacturing a vibrator including a mesh structure according to an embodiment of the present invention.

### DETAILED DESCRIPTION

Hereinafter, embodiments will be described in greater detail with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present invention. Furthermore, ‘and/or’ may include any one of or a combination of the components mentioned.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

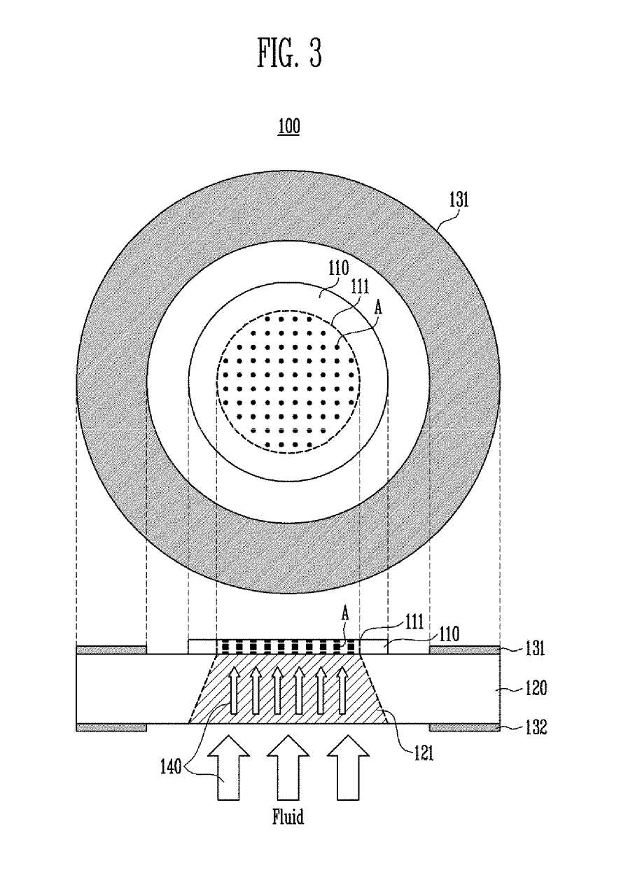

FIG. 2 is a schematic view illustrating a method for manufacturing a vibrator including a mesh structure according to an embodiment of the present invention. Referring to FIG. 2, a method for manufacturing a vibrator including a mesh structure according to an embodiment of the present invention consists of a simplified process of 2 steps.

First of all, a vibrator structure is manufactured in a single process 21 where the vibrator is integrated with a mesh structure. The mesh structure and the vibrator structure are coupled firmly to each other.

Meanwhile, the single process 21 may be a process of etching or depositing an object made of a certain lump of material so as to manufacture one object where a mesh structure and a vibrator structure are integrated.

Then, a process of completing the vibrator 22 (hereinafter referred to as including the mesh structure is performed where another structure such as a power source electrode and the like is added to the vibrator structure integrated with the mesh structure 22 (hereinafter referred to as the completing process). The completing process 22 may further include, besides the process of forming a power source electrode and the like, a process of trimming a coarse surface of the mesh structure and vibrator structure, an etching process in order to form an additional structure such as a hole or screw hole and the like, and a cutting process or polishing process and the like.

Meanwhile, the completing process 22 does not include a process of coupling the mesh structure and vibrator structure unlike in a conventional method. The mesh structure and vibrator structure had been formed as an integrated object at the single process 21, and thus there is no need for a process of coupling the mesh structure and the vibrator structure at the completing process 22.

According to the aforementioned process of the present invention 20, the mesh structure and vibrator structure are formed as one object through one single process. Therefore, there is no need for a process of coupling the vibrator and the mesh, and it is possible to manufacture a vibrator that includes a mesh structure through a more simplified process than in a conventional method. Furthermore, unlike in a conventional method where a different process had to be applied to a mesh and a vibrator, respectively, according to an embodiment of the present invention, a mesh structure and vibrator are manufactured in one common process, and thus the manufacturing process may be much more simplified.

Furthermore, according to the aforementioned process of the present invention 20, a mesh structure and vibrator structure are formed through a single process, and thus the mesh structure and vibrator structure are coupled firmly to each other. Therefore, the structure of the vibrator becomes much more firm and strong compared to a mesh structure made by mechanical coupling or an adhesive according to a conventional method.

Therefore, the vibrator manufactured may be much more firm and strong compared to a mesh vibrator manufactured by mechanical method or an adhesive according to a conventional method.

Moreover, since the process is reduced and simplified, the yield rate of the vibrator including a mesh structure may be improved, the manufacturing cost may be reduced, and a physically more firm structure may be manufactured, thereby improving the durability and stability of the vibrator including the mesh structure.

FIG. 3 is a plane cross-sectional view illustrating an exemplary structure of a vibrator including a mesh structure according to an embodiment of the present invention. Referring to FIG. 3, a vibrator 100 including a mesh structure includes a mesh structure 100, vibrator structure 120, and one or more electrodes 131, 132.

In the embodiment of FIG. 3, the mesh structure 110 and vibrator structure 120 are manufactured as one object by the single process 21 explained in FIG. 2, the mesh structure 110 and vibrator structure 120 firmly coupled to each other. Therefore, there is no coupling gap between the mesh structure 110 and vibrator structure 120.

The vibrator structure 120 is a main body that provides vibration to the vibrator 100. The vibrator structure 120 provides vibration to the vibrator 100 by making a vibratory motion by a voltage applied to electrodes 131, 132 that will be explained hereinafter.

In a center of the vibration structure 120, a hollow 121 is formed. When fluid 140 is introduced from outside, the hollow 121 guides a proceeding path of the fluid 140. In an embodiment, the hollow 121 may be configured such that its radius or cross-section gets smaller as it gets closer from an inlet where the fluid 140 is introduced towards the mesh structure 110. In an embodiment, the hollow 121 may be manufactured by etching a portion or an entirety of an integrated object of the vibrator structure 120 and mesh structure 110.

The mesh structure 110 is formed on the vibrator structure 120 such that it touches an upper portion of the hollow 121 of the vibration structure 120. The mesh structure 110 includes a porous mesh 111 having a plurality of holes A, and the fluid 140 introduced through the hollow 121 when the vibration structure 120 makes a vibratory motion passes the porous mesh 111 and is sprayed or spilt to the upper portion of the mesh structure 110. Herein, a proceeding direction of the fluid 140 is a direction towards the upper portion of the mesh structure 110.

The electrodes 131, 132 provide a voltage for causing vibration of the vibrator structure 120. In the embodiment of FIG. 3, of the electrodes 131, 132, the first electrode 131 is formed on an upper surface of the vibrator structure 120, and the second electrode 132 is formed on a lower surface of the vibrator structure 120. The first electrode 131 and the second electrode 132 are physically spaced from each other.

For example, the electrodes 131, 132 are configured such that a voltage applied between the first electrode 131 and the second electrode 132 cause vibration in the vibrator structure 120. Herein, the first electrode 131 may be a power source electrode having for example a potential of 5V, and the second electrode 132 may be a ground electrode having a ground potential.

However, this is just an example, and thus the scope of the present invention is not limited to the aforementioned. For example, the second electrode 132 may not necessarily have a ground potential as long as it has a potential lower than the first electrode 131.

Furthermore, herein, an assumption is made that the potential of the first electrode 131 is higher than that of the second electrode 132, but this is just an example, and thus the scope of the present invention is not limited thereto. For example, the second electrode 132 may consist of a power source electrode and the first electrode 131 may consist of a ground electrode. In an embodiment, the vibrator structure 120, hollow 121, mesh structure 110, porous mesh 111, first electrode 131, or second electrode 132 of FIG. 3 may be configured to have a concentric circle when seen from above. However, this is also just an example, and thus the vibrator structure 120, hollow 121, mesh structure 110, porous mesh 111, first electrode 131, or second electrode 132 may be configured to have another shape.

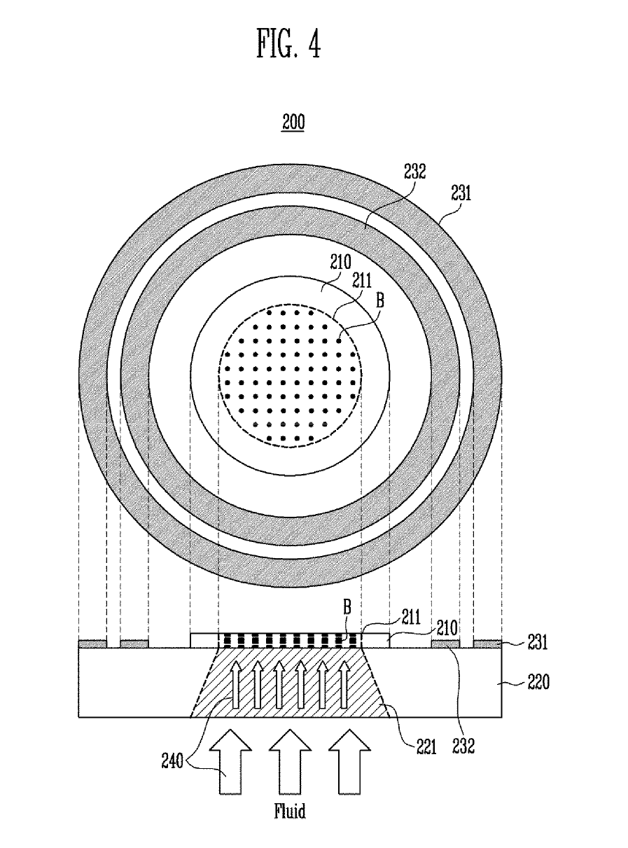

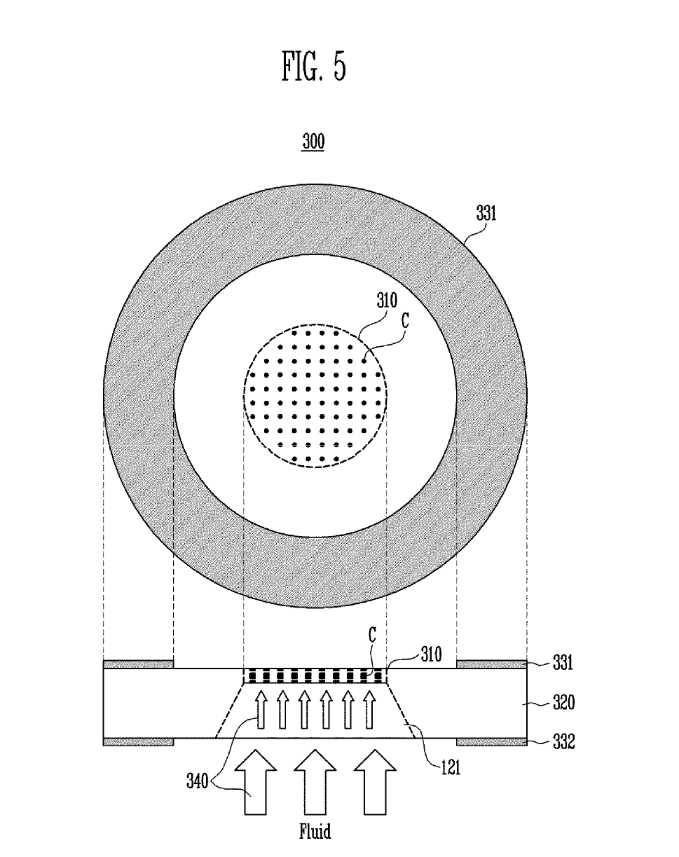

FIG. 4 is a plane and cross-sectional view illustrating an exemplary structure of a vibrator including a mesh structure according to an embodiment of the present invention. Referring to FIG. 4, the vibrator 200 including a mesh structure includes a mesh structure 210, vibrator structure 220 and one or more electrodes 231, 232.

Similarly to FIG. 3, in an embodiment of FIG. 4, the mesh structure 210 and vibrator structure 220 are manufactured as one object by the single process 21 explained in the aforementioned FIG. 2. Therefore, there is no coupling gap between the mesh structure 210 and vibrator structure 220.

However, in the embodiment of FIG. 4, the first electrode 231 and second electrode 232 are both formed on an upper portion of the vibrator structure 220, unlike in the embodiment of FIG. 3.

The vibrator structure 220 is a main body that provides vibration to the vibrator 200. The vibrator structure 220 provides vibration to the vibrator 100 by making a vibratory motion by a voltage applied to the electrodes 231, 232.

The vibrator structure 220 may be configured substantially the same as the vibrator structure 120 explained in FIG. 3. For example, the vibrator structure 120 may have a hollow 221 that guides a proceeding path of the fluid 240 in the same manner as in FIG. 3.

The mesh structure 210 is formed on the vibrator structure 120 such that it touches the upper portion of the hollow 221 of the vibrator structure 220, and the fluid 240 introduced through the hollow 221 passes the mesh structure 210 and is sprayed or spilt to the upper portion of the mesh structure 110.

The mesh structure 210 may be configured substantially the same as that of the mesh structure 110 explained in FIG. 3. For example, the mesh structure 210 may have a porous mesh 211 having a plurality of holes B in the same manner as in FIG. 3.

The electrodes 231, 232 provide a voltage for causing vibration of the vibrator structure 220. In an embodiment of FIG. 4, the first electrode 231 and second electrode 232 are formed on an upper surface of the vibrator structure 220 together, unlike in FIG. 3. For example, when the first electrode 231 is formed on the upper surface of the vibrator structure 220, the second electrode 132 may be inside the first electrode 231 such that it is physically spaced from the first electrode 231.

For example, the electrodes 231, 232 are configured such that a voltage applied between the first electrode 231 and second electrode 232 causes vibration to the vibrator structure 220. For example, herein, the first electrode 231 may be a power source electrode having a potential of 5V, and the second electrode 232 may be a ground electrode having a ground potential.

However, this is just an example, and thus the scope of the present invention is not limited thereto. For example, the second electrode 232 may not necessarily have a ground potential as long as it has a potential lower than that of the first electrode 231.

Furthermore, herein, an assumption is made that the potential of the first electrode 231 is higher than the potential of the second electrode 232, but this is just an example, and thus the scope of the present invention is not limited thereto. For example, the second electrode 232 may consists of a power source electrode and the first electrode 231 may consist of a ground electrode. In an embodiment, the vibrator structure 220, hollow 221, mesh structure 210, porous mesh 211, first electrode 231, or second electrode 232 of FIG. 4 may be configured to have a concentric circle when seen from above. However, this is also just an example, and thus the vibrator structure 220, hollow 221, mesh structure 210, porous mesh 211, first electrode 231, or second electrode 232 may be configured to have another shape other than a concentric circle.

According to the configuration of FIG. 4, the first electrode 231 and second electrode 232 are formed on a same plane as the vibrator structure 220, and thus the first electrode 231 and second electrode 232 may be formed further easily, thereby further simplifying the process of forming an electrode (for example, the completing process 22 of FIG. 2).

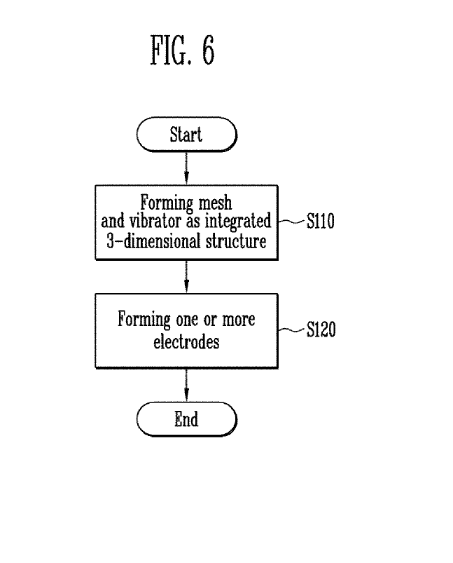

FIG. 5 is a plane cross-sectional view illustrating an exemplary structure of a vibrator including a mesh structure according to another embodiment of the present invention. Referring to FIG. 5, the vibrator 300 including a mesh structure includes a mesh structure 310, vibrator structure 320 and one or more electrodes 331, 332.

Similarly to FIG. 3, in an embodiment of FIG. 5, the mesh structure 310 and vibrator structure 320 are manufactured as one object by the single process 21 explained in the aforementioned FIG. 2. Therefore, there is no coupling gap between the mesh structure 310 and vibrator structure 320.

However, in the embodiment of FIG. 5, there is a difference from FIG. 3 in that the mesh structure 310 is configured to be depressed into the vibrator structure 320.

The vibrator structure 320 may be configured substantially the same as the vibrator structure 120 explained in FIG. 3. For example, the vibrator structure 120 may have a hollow 321 that guides a proceeding path of the fluid 240 in the same manner as in FIG. 3.

The mesh structure 310 is configured such that its portion or entirety is depressed into the vibrator structure 320, while touching an upper portion of the hollow 321 of the vibrator structure 320. In such a case, the mesh structure 310 may be formed by etching or perforating a portion of the vibrator structure 320.

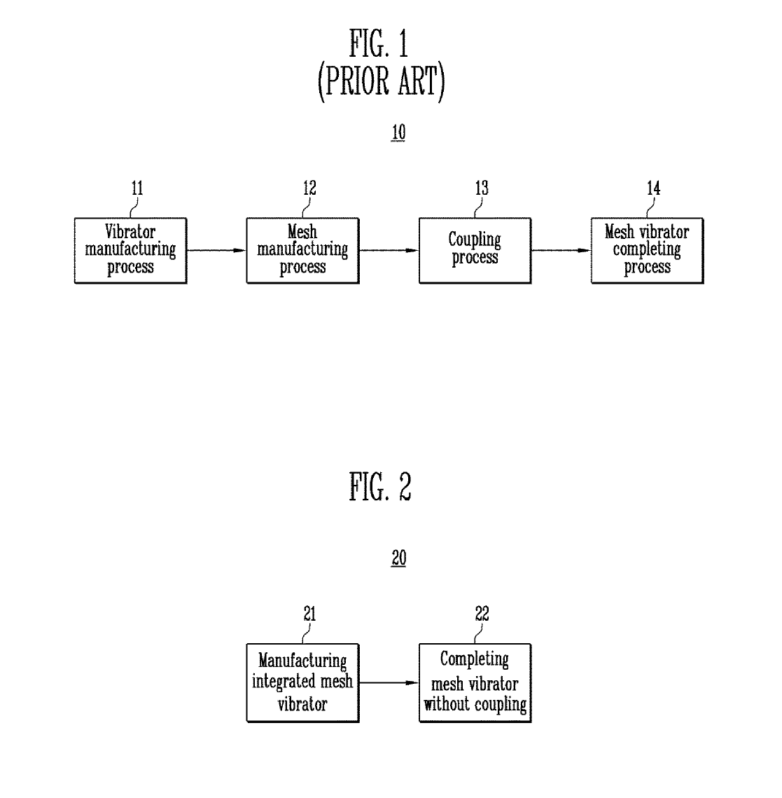

The configuration of the mesh structure 310 is substantially the same as the mesh structure 110 of FIG. 1 except that a portion or entirety of the mesh structure 310 is depressed into the vibrator structure 320. For example, the mesh structure 310 has a porous mesh 310 having a plurality of holes C in the same manner as in FIG. 3.

The electrodes 331, 332 provide a voltage that causes vibration of the vibrator structure 320. The first electrode 331 and second electrode 332 may be physically spaced from each other.

The configuration of the electrodes 331, 332 may be substantially the same as the electrodes 131, 132 explained in FIG. 3 or electrodes 231, 232 explained in FIG. 4. For example, the electrodes 331, 332 may be configured to cause vibration to the vibrator structure 320 in the same manner as the electrodes 131, 132 of FIG. 3 or electrodes 231, 232 of FIG. 4.

In an embodiment, the vibrator structure 320, hollow 321, mesh structure 310, first electrode 331, or second electrode 332 of FIG. 3 may be configured to have a concentric circle when seen from above. However, this is also just an example, and thus the vibrator structure 320, hollow 321, mesh structure 310, first electrode 331, or second electrode 332 may be configured to have another shape.

FIG. 6 is an exemplary flowchart of a method for manufacturing a vibrator including a mesh structure according to an embodiment of the present invention. Referring to FIG. 6, a method for manufacturing a vibration including a mesh structure includes step 110 and step 120.

At step 110, a mesh structure and vibrator structure are formed as one integrated 3-dimensional structure through a single process. The configuration of the mesh structure and vibrator structure formed in the single process and a result thereof are the same as in FIGS. 2 to 5. For example, the mesh structure and vibrator structure may be formed to have one of the configurations of embodiments FIGS. 3 to 5, by the single process 21 explained in FIG. 2.

At step 120, an electrode unit including one or more electrodes is formed in the vibrator structure formed at step 110. Herein, the electrode unit may be formed to have the same configuration as the electrodes 131, 132; 231, 232; or 331, 332 explained in FIGS. 3 to 5. When the forming of the electrode unit is completed, manufacturing of vibrator including a mesh structure is completed.

According to the method for manufacturing the vibrator including the mesh structure, a vibrator including a mesh structure and vibrator structure is formed as one object through a single process. Therefore, there is no need for a process of coupling the vibrator and the mesh, and thus the vibrator including a mesh structure may be manufactured in a further simplified process compared to conventional methods. Furthermore, according to the various embodiments of the present invention, unlike in conventional methods where a different process is applied to a mesh and a vibrator, a mesh structure and a vibrator may be manufactured in one common process, thereby significantly simplifying the manufacturing process.

Furthermore, according to the various embodiments of the present invention, a single process of directly forming a mesh structure in a vibrator structure is applied, and thus the vibrator structure and the mesh structure may be coupled firmly. Therefore, the vibrator manufactured may be much more firm and strong compared to a mesh vibrator manufactured by mechanical method or an adhesive according to a conventional method.

Moreover, since the process is reduced and simplified, the yield rate of the vibrator including a mesh structure may be improved, the manufacturing cost may be reduced, and a physically more firm structure may be manufactured, thereby improving the durability and stability of the vibrator including the mesh structure.

Meanwhile, in the present specification, as assumption is made that the electrode unit includes only two electrodes, but there is no limitation thereto. The shape and position of the electrode unit in the vibrator including a mesh structure according to embodiments of the present invention are not limited to the aforementioned structure, shape, and position, but may be realized into the structure, shape, and position capable of causing vibration using one or more electrodes. For example, the electrode unit may have three or more electrodes, or just one electrode. For example, when the electrode unit has only one electrode, a portion of the vibrator structure or mesh structure may function as an opposite electrode. Furthermore, the vibrator including the mesh structure may further include a vibration control means capable of controlling a vibration parameter (for example, vibration direction or vibration frequency). Herein, the vibration control means may find out a displacement of the vibrator by measuring an impedance of the vibrator being changed by the vibration of the vibrator structure, and control or monitor the vibration parameter of the vibrator based on the displacement that is found out. Further details of the vibration control means are well known in the related field, and thus explanation thereof is omitted.

In the drawings and specification, there have been disclosed typical embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A vibrator comprising a mesh structure, the vibrator comprising:
a vibrator structure including a hollow configured to introduce fluid from outside;
a mesh structure configured to touch the hollow and include a porous mesh including a plurality of holes; and
an electrode unit configured to apply a voltage for causing vibration of the vibrator structure to the vibrator,
wherein the vibrator structure and mesh structure are configured as one integrated object, and
the voltage is a direct voltage or alternating voltage.

2. The vibrator according to claim 1,
wherein the vibrator structure and mesh structure are formed as the one integrated object through a single process of processing a lump of material into the one integrated object.

3. The vibrator according to claim 2,
wherein the single process is a process of forming the one integrated object by etching or depositing the lump of material.

4. The vibrator according to claim 1,
wherein the mesh structure is formed on a surface of the vibrator structure.

5. The vibrator according to claim 1,
wherein a portion or entirety of the mesh structure is depressed into the vibrator structure.

6. The vibrator according to claim 1,
wherein the electrode unit comprises:
a first electrode where the current is introduced; and
a second electrode where the current introduced is discharged.

7. The vibrator according to claim 6,
wherein the first electrode is formed on a surface of the vibrator structure, and
the second electrode is formed on another surface of the vibrator structure different from the surface.

8. The vibrator according to claim 6,
wherein the first electrode and second electrode are formed on a same surface of the vibrator structure.

9. The vibrator according to claim 1,
wherein the fluid proceeds in a direction towards an upper surface of the mesh structure through the hollow from a lower surface of the vibrator structure.

10. The vibrator according to claim 9,
wherein a cross-section of the hollow decreases as it gets closer to the mesh structure.

11. A method for manufacturing a vibrator comprising a mesh structure, the method comprising:
forming a vibrator structure and mesh structure by processing a lump of material as one object through a single process; and
forming on the vibrator structure an electrode unit configured to apply a voltage for causing vibration of the vibrator structure to the vibrator,
wherein the vibrator structure and mesh structure are formed as one integrated object,
the vibrator structure includes a hollow configured to introduce fluid from outside,
the mesh structure touches the hollow and includes a porous mesh including a plurality of holes, and
the voltage is a direct voltage or alternating voltage.
